(19) United States
(12) Patent Application Publication
(10) Pub. No.: US 2006/0071657 A1
(43) Pub. Date: Apr. 6, 2006

(54) Integrated circuit with speed measurement circuitry

(76) Inventors: James R. Emmert, Corvallis, OR (US); Charles Evans, Corvallis, OR (US); Michael A. Rencher, Corvallis, OR (US)

Correspondence Address: AVAGO TECHNOLOGIES, INC., P.O. BOX 1920, DENVER, CO, 80201-1920, US

(21) Appl. No.: 10/897,531

(22) Filed: Jul. 23, 2004

(51) Int. Cl. G01P 3/42

(52) U.S. Cl. 324/160

(57) ABSTRACT

An integrated circuit having a speed measurement circuit that generates an indicator of a speed of the integrated circuit in response to a test signal. The speed measurement circuit obviates the need to repeatedly apply test signals at different clock frequencies to an integrated circuit or to externally measure delay time.

### BACKGROUND

A manufacturing process for an integrated circuit may include a series of process steps for forming the structures of a set of circuit elements on each of a set of integrated circuit dies contained on a wafer. Examples of process steps include material deposition steps and material patterning steps. Examples of circuit elements that may be formed on an integrated circuit die include buffers, latches, inverters, data paths, as well as more complex circuits.

A manufacturing process for an integrated circuit may yield variations in the structures formed on different integrated circuit dies. For example, a material deposition step may yield different thicknesses or qualities of material deposited on different dies or a patterning step may yield different geometries of structures patterned on different dies.

Variations in the structures formed on different integrated circuit dies may cause variation in the speed characteristics of the circuit elements of different dies. For example, analogous structures formed on different integrated circuit dies may have different switching speeds, signal propagation delays, etc.

Variations in the speed characteristics of the circuit elements on different integrated circuit dies may yield variations in the maximum clock speed of different integrated circuit dies. As a consequence, a manufacturing process for an integrated circuit may include a speed test. The results of a speed test may be used, for example, to classify an integrated circuit die according to its maximum allowable clock speed.

A prior speed test for an integrated circuit may include repeatedly performing a functional test on its circuit elements using a variety different clock speeds and examining the results of the functional test at each clock speed. Unfortunately, such a technique may increase the cost of a manufacturing process by increasing the time consumed by performing speed tests and may increase the cost of test equipment.

Another prior speed test for an integrated circuit includes using a ring oscillator to apply a test signal to a delay circuit on the integrated circuit and using a time measurement circuit to measure the delay in the test signal as it traverses the delay circuit. Unfortunately, a ring oscillator and time measurement circuit may increase the cost of test equipment.

### SUMMARY OF THE INVENTION

An integrated circuit having a speed measurement circuit is disclosed. The speed measurement circuit generates an indicator of a speed of the integrated circuit in response to a test signal. The speed measurement circuit obviates the need to repeatedly apply test signals at different clock frequencies to an integrated circuit to determine its speed or to externally measure delay time.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a top view of a wafer that includes an integrated circuit die with a speed measurement circuit according to the present techniques;

FIG. 2 shows one embodiment of a speed measurement circuit according to the present techniques;

FIG. 3 shows a timing diagram of an example speed test on an integrated circuit die according to the present techniques;

FIG. 4 shows a method for performing a speed test on an integrated circuit die according to the present techniques.

### DETAILED DESCRIPTION

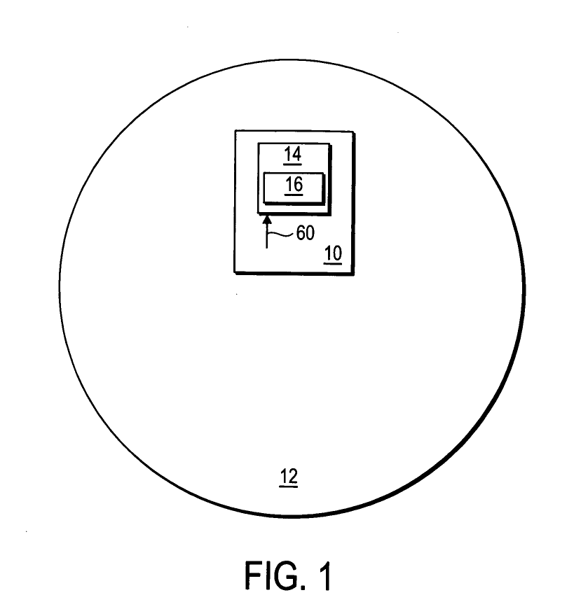

FIG. 1 shows a top view of a wafer 12 that includes an integrated circuit die 10 with a speed measurement circuit 14 according to the present techniques. The integrated circuit die 10 may include any type of integrated circuit, e.g. an application-specific integrated circuit (ASIC). The wafer 12 may hold a number of integrated circuit dies.

The speed measurement circuit 14 measures a speed of the integrated circuit die 10 in response to a test signal 60. The test signal 60 may be generated by circuitry on the integrated circuit die 10, e.g. circuit elements for generating a clock signal, or may be applied to the integrated circuit die 10 externally, e.g. during a wafer probe test. The speed measurement circuit 14 includes a speed register 16 that captures an indicator of the speed of the integrated circuit die 10 in response to the test signal 60.

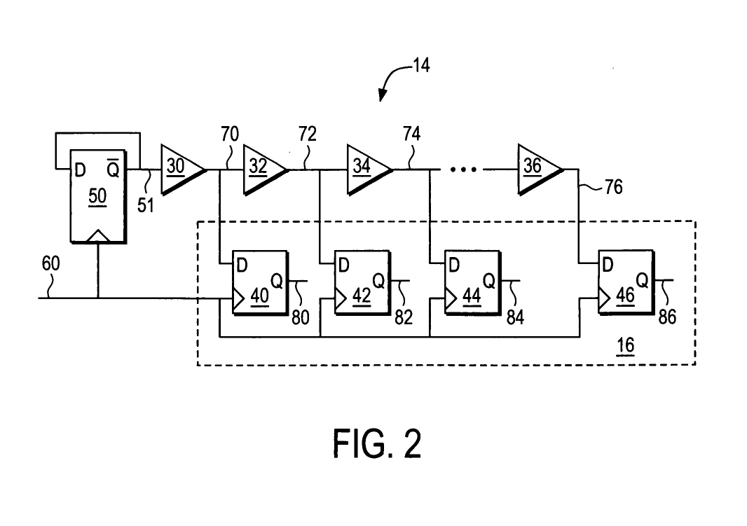

FIG. 2 shows one embodiment of the speed measurement circuit 14. The speed measurement circuit 14 includes a flip-flop 50 that generates a signal at its output 51 in response to the test signal 60 at its clock input. The speed measurement circuit 14 includes a series of buffers 30-36 that propagate the signal from the output 51 of the flip-flop 50. In other embodiments, the buffers 30-36 may be replaced with other types of circuit elements, e.g. inverters.

The speed measurement circuit 14 includes a set of observation flip-flops 40-46 that respectively correspond to the buffers 30-36. Each observation flip-flop 40-46 samples a corresponding buffer output 70-76 of the buffers 30-36 in response to the test signal 60 applied to its clock input. The observation flip-flops 40-46 taken together provide the speed register 16 for capturing a value that indicates how far the signal generated at the output 51 of the flip-flop 50 propagates down the series of buffers 30-36 between edges of the test signal 60.

For example, a “1” at an output 80 of the observation flip-flop 40 indicates that the signal from the output 51 propagated past the buffer 30 between edges of the test signal 60 and a “1” at an output 82 of the observation flip-flop 42 indicates that the signal from the output 51 propagated past the buffers 30 and 32 between edges of the test signal 60. Likewise, a “1” at an output 84 of the observation flip-flop 44 indicates that the signal from the output 51 propagated past the buffers 30 and 32 and 34 between edges of the test signal 60, etc.

The data held in the flip-flops 40-46 after at least two edges of the test signal 60 indicate the speed of signal propagation on the integrated circuit die 10. The flip-flops 40-46 may be read to obtain a speed indicator for the integrated circuit die 10. For example, an indicator from the flip-flops 40-46 of “1000” indicates a slow speed in comparison to “1100” which is relatively slow in comparison to “1110” and so on.

The contents of the flip-flops 40-46 may be read out of the integrated circuit die 10 via its input/output pads during a wafer probe test on the integrated circuit die 10. Alternatively, the contents of the flip-flops 40-46 may be read out of the integrated circuit die 10 via scan ports during a vector test mode on the integrated circuit die 10.

In an alternative embodiment, the flip-flops 40-46 and 50 may be replaced with latches.

In an alternative embodiment, the D input to the flip-flop or latch 50 may be set to a “1” state using a circuit that may be reset.

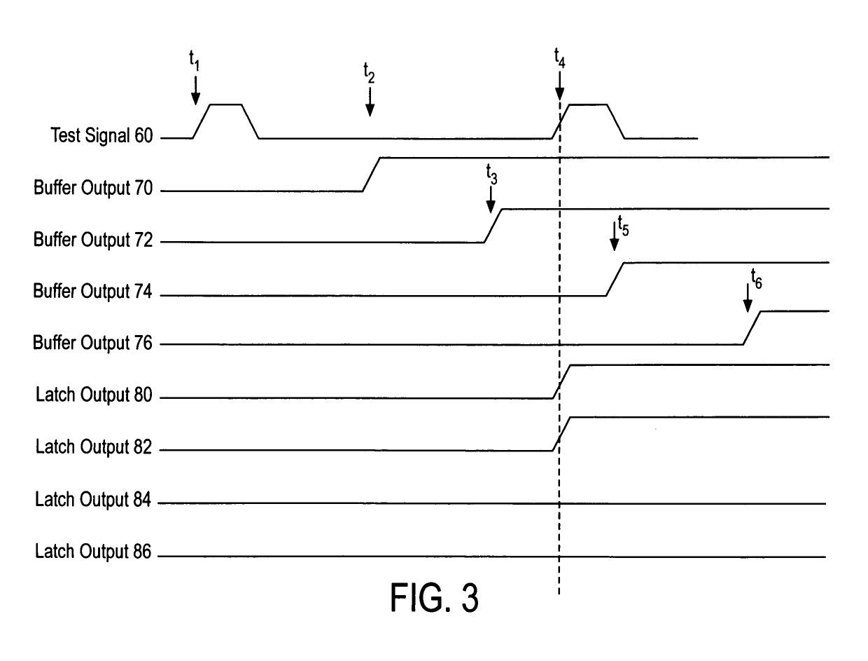

FIG. 3 shows a timing diagram of an example speed test on the integrated circuit die 10 according to the present techniques. The test signal 60 includes a first edge at a time t1 and a second edge at a time t4. The first edge of the test signal 60 causes the output 51 of the flip-flop 50 to switch to a high state, i.e. a “1” state, after time t1.

At time t2, the output 70 of the buffer 30 switches to the high state in response to the high state at the output 51. At time t3, the output 72 of the buffer 32 switches to the high state in response to the high state at the output 70. Similarly, at time t5 the output 74 of the buffer 34 switches to the high state in response to the high state at the output 72 and at time t6 the output 76 of the buffer 36 switches to the high state in response to the high state at the output 74.

The second edge of the test signal 60 at time t4 captures the states of the outputs 70-76 using the observation flip-flops 40-46. After time t4, the output 80 of the observation flip-flop 40 holds the “1” state of the output 70, the output 82 of the observation flip-flop 42 holds the “1” state of the output 72, the output 84 of the observation flip-flop 44 holds the “0” state of the output 74, and the output 86 of the observation flip-flop 46 holds the “0” state of the output 76.

The “1100” outputs of the observation flip-flops 40-46 provide a speed indicator for the integrated circuit die 10. Speed variations in the integrated circuit die 10 are reflected in the data captured by the observation flip-flops 40-46. For example, manufacturing process variations may cause the output 74 to switch to the high state before the second edge at time t4 which would yield a speed indicator of “1110.” On the other hand, process variations may prevent the output 72 from switching to the high state before the second edge at time t4 which would yield a speed indicator of “1000.”

The speed of propagation of the test signal 60 through the buffers 30-36 may be determined in response to the speed indicator obtained from the speed register 16 and the frequency of the test signal 60. For example, a speed indicator of “1100” indicates that two of the buffers 30-36 switched during the time interval t4-t1. The frequency of the test signal 60 may be pre-selected so that the time t4 is timed to capture speed variations caused by manufacturing process variations.

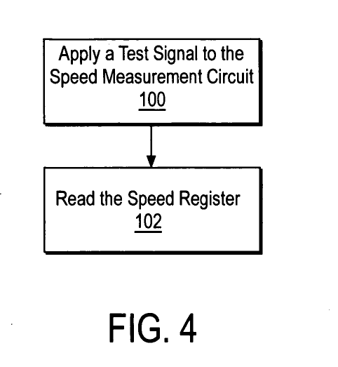

FIG. 4 shows a method for performing a speed test on the integrated circuit die 10 according to the present techniques. At step 100, the test signal 60 including a first edge and a second edge is applied to the speed measurement circuit 14. The test signal 60 may be generated using signal generation circuitry on the integrated circuit die 10 or may be generated externally and applied to the integrated circuit die 10, e.g. during a wafer probe.

At step 102, the contents of the speed register 16 are read to obtain an indicator of the speed of the integrated circuit die 10. The speed register 16 may be read out via the input/output pads during a wafer probe test mode. Alternatively, the speed register 16 may be scanned out serially from the integrated circuit die 10 during a vector test. In another alternative, the speed register 16 may be read by a microprocessor that is implemented on the integrated circuit die 10.

The flip-flops 40-46 and 50 may be reset to a zero state before the test signal is applied at step 100 to set initial conditions for the speed test.

In an alternative to setting initial conditions for the flip-flops 40-46 and 50, the following sequence may be performed. The test signal 60 including a first edge and a second edge is applied to the speed measurement circuit 14 followed by a first read of the speed register 16. Thereafter, the test signal 60 including a first edge and a second edge is applied to the speed measurement circuit 14 followed by a second read of the speed register 16. The bits of the speed register 16 that change state between the first and the second read indicate the speed of the integrated circuit 10.

A speed test according to the present techniques may be performed after the integrated circuit die 10 is cut away from the wafer 12 and packaged into a chip package including input/output pins. For example, the input/output pins of a chip package may be used to apply the test signal 60 and then read the contents of the speed register 16.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. An integrated circuit having a speed measurement circuit that generates an indicator of a speed of the integrated circuit in response to a test signal.

2. The integrated circuit of claim 1, wherein the speed measurement circuit includes a series of circuit elements for propagating a signal in response to the test signal.

3. The integrated circuit of claim 2, wherein the circuit elements include a series of buffers.

4. The integrated circuit of claim 2, wherein the circuit elements include a series of inverters.

5. The integrated circuit of claim 2, wherein the speed measurement circuit includes an observation circuit for each circuit element, each observation circuit sampling an output of the corresponding circuit element.

6. The integrated circuit of claim 5, wherein each observation circuit samples the corresponding output in response to the test signal.

7. The integrated circuit of claim 6, wherein the observation circuits provide a register that indicates a number of the circuit elements through which the signal propagated between a pair of edges of the test signal.

8. A method for determining a speed of an integrated circuit, comprising:
applying a test signal to a speed measurement circuit on the integrated circuit;
reading an indicator of the speed of the integrated circuit from a speed register of the speed measurement circuit.

9. The method of claim 8, wherein applying a test signal includes applying the test signal during a wafer probe test.

10. The method of claim 8, wherein applying a test signal includes applying the test signal via an input/output pad of the integrated circuit.

11. The method of claim 8, wherein reading an indicator includes reading the speed register during a wafer probe test.

12. The method of claim 8, wherein reading an indicator includes reading the speed register via an input/output pad of the integrated circuit.

13. The method of claim 8, wherein reading an indicator includes reading the speed register using a microprocessor on the integrated circuit.
